(19) United States
(12) Patent Application Publication
(10) Pub. No.: US 2020/0330315 A1
(43) Pub. Date: Oct. 22, 2020

(54) System and Method for Applying Manipulative Myofascial Therapy

(71) Applicants: Tala Khalaf, San Carlos, CA (US); Ismail Bustany, San Carlos, CA (US)

(72) Inventors: Tala Khalaf, San Carlos, CA (US); Ismail Bustany, San Carlos, CA (US)

(21) Appl. No.: 16/852,403

(22) Filed: Apr. 17, 2020

Related U.S. Application Data
(60) Provisional application No. 62/835,936, filed on Apr. 18, 2019.
(60) Provisional application No. 62/835,982, filed on Apr. 18, 2019.

(51) Int. Cl. A61H 7/00

(52) U.S. Cl. CPC A61H 7/004; A61H 2201/1692; A61H 2201/1659; A61H 2201/5071; A61H 1/00; A61H 2230/60; A61H 2201/0207; A61H 2201/10; A61H 2201/5082

(57) ABSTRACT

In one embodiment, a handheld device for applying therapy includes a housing, a handle coupled to the housing, a motor supported in the housing, a movable head coupled to the motor, and a contact pad of high-friction, grippy, non-slip material supported on the movable head. The motor is operable to impart to the movable head and the contact pad one or more of translational, rotational, or revolutionary motions that are generally in a plane parallel to the skin of a patient during operation.

### CROSS-REFERENCE TO RELATED APPLICATIONS

This application claims the benefit of U.S. provisional patent applications Nos. 62/835,936 filed Apr. 18, 2019, and 62/835,982 filed Apr. 18, 2019, the contents of both of which are incorporated herein by reference in their entirety.

### TECHNICAL FIELD

The present disclosure relates generally to physical therapy devices.

### BACKGROUND

Fascia is a physiological system that constitutes a large network of cobweb-like (3D) features that cover all the muscles, tendons, ligaments, joints and viscera of the human body. Until recently, there has been little scientific research in the realm of the fascia. It used to be the first “organ” that medical students would cut through during their anatomical dissections and discard while examining the organs that the fascia permeates. However, in the recent decade, the scientific and medical community started paying more attention to the important neurologic/physiologic roles that fascia plays in the human body, and more evidence-based research has been conducted. “Fascia is collagenous connective tissue surrounding and interpenetrating skeletal muscle, joints, organs, nerves, and vascular beds. It forms a whole-body, continuous 3D viscoelastic matrix of structural support and contains contractile elements enabling a modulating role in force generation and mechanosensory fine-tuning. Spontaneous regulation of fascial stiffness over a period of minutes to hours actively contributes to musculoskeletal dynamics. Imbalance of this regulatory mechanism can impair myofascial tonus, or diminished neuromuscular coordination, which are key contributors to the patho-mechanisms of several musculoskeletal pathologies and pain syndromes,” Paolo Tozzi, MSc Ost, DO, PT “ A unifying neuro-fasciagenic model of somatic dysfunction—Underlying mechanisms and treatment” —Part I, JBWMT, April 2015, Volume 19, Issue 2, Pages 310-326. The superficial fascia, which lies beneath the dermis and adipose tissue is rich with proprioceptors and mechanoreceptors. These receptors maintain the homeoastais of the connective tissue in check. If there is a disturbance to the homeostasis, which is caused by any strain to the local tissue, these mechanoreceptors will communicate the insult to the nervous system. The nervous system, in turn, sends protective signals to affected tissue that induce local spasms, resulting in more tightness and pain. These local trigger/tender points, left untreated, cause chronic pain. There are currently no devices that target superficial or deep fascia manipulation. Rather, existing devices perform kneading, and/or shiatsu, and/or percussion, and/or vibration only. Some of these prior are devices are hand-held by a therapist, and pressed against the patient's body, but they only operate to deliver percussive forces, not force in transverse (side-to-side) directions.

### OVERVIEW

As a form of therapy, for example to deactivate mechanoreceptors in fascia and alleviate pain and discomfort, passive steady and slow manual pressure/decompression manipulations of the connective tissue can deactivate these mechanoreceptors and release spasms. Decompression/shortening maneuvers applied to the connective tissue has been found to be effective. A slackening maneuver has a deactivation effect of the body's mechanoreceptors which trap inflammation in the inter-cell or interstitial tissue space. During manual treatment of fascial decompression/or slackening, there is a palpable, often visible reduction in localized tissue edema which helps alleviate the chemical component of chronic soft tissue dysfunction. The combination of inflammation drainage and pain receptor “deactivation” gives this maneuver unparalleled effect and carry over.

In certain embodiments, an intelligent, wearable, non-slip, free-standing, “robotic inspired hand” that senses myofascial stiffness in a target tissue area and mobilizes fascia to release tension is provided. In certain embodiments, the device is controllable with a software application, for example an IOS/Android App on a mobile device, to control grip actuator(s), log historical stiffness measurements, provide users with therapeutic exercises that augment myofascial release, provide an educational platform for resources on fascial health with respect to nutrition, proper posture, body mechanics, and flexibility exercises. Also, it enables a remote touch mode that (raises Oxytocin feel-good/cuddle hormone level).

In certain embodiments, a passive free-standing device can be provided to administer manipulative fascial therapy. The passive device can simply be positioned on the body part and it will cling by its conforming properties/materials. The user then is free to work, walk, and exercise.

In certain embodiments the device will adjuvantly apply heat and or other energy, such as light or vibrations.

In certain embodiments the superficial fascia is manipulated by decompressing and slackening the myofascial tissue. This mechanically deactivates receptors and signals the nervous system to reset and stop its protective messages to the tissue thereby halting the chronic spasms that can be debilitating, and limiting of strength, range of motion, mobility, and functional activities.

In certain embodiments the device includes a component to target the deep fascia by performing a deep transverse friction massage to resolve debilitating “densifications.” It impinges the fascia by manipulations such as slackening and releasing and/or friction massage, for example to loosen or resolve fascia densification. In certain embodiments, it takes a free-standing, wearable form factor. In certain embodiments, it is capable of logging history of myofascial stiffness and muscle tonicity and other factors for individual users who have their own custom accounts, which can be one of many that a particular device is associated with.

In certain embodiments, a free-standing device for applying manipulative fascial therapy includes one or more actuators, at least two opposable digits that are movably supported relative to one another at proximal ends thereof, each opposable digit having a contact pad of high-friction material at a portion thereof, and a controller operable to signal one or more of the actuators to impart to at least a first opposable digit of the one or more opposable digits a squeezing motion to thereby move the contact pad thereof toward a contact pad of a second opposable digit of the one or more opposable digits, and to impart to a contact pad of an opposable digit of the one or more opposable digits at least one of a loosening motion, a transverse motion, or a penetrative motion.

In certain embodiments, a handheld device for applying therapy includes a housing, a handle coupled to the housing, a motor supported in the housing, a movable head coupled to the motor, and a contact pad of high-friction, material supported on the movable head. The motor is operable to impart to the movable head and the contact pad one or more of translational, rotational, or revolutionary motions that are generally in a plane parallel to the skin of a patient during operation.

In certain embodiments, a free-standing device for applying manipulative therapy includes first and second clam shell portions hingeably supported for movement relative to one another in opening and closing motions, and a brake for selectively substantially retaining the relative position of the first and second claim shell portions. Each of the first and second clam shell portions includes a conformable portion for conforming to a shape of a body part when the two clam-shell portions are closed against said body part.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIGS. 1A-1C are schematic diagrams showing the application of manipulative fascial therapy in accordance with certain embodiments;

FIG. 2 depicts possible motions of various components of in accordance with certain embodiments;

FIG. 3 is a diagram of a multi-articulated device 30, in the form of a robotic hand, for applying therapeutic manipulation mimicking a human hand in accordance with certain embodiments;

FIG. 4 is a schematic view of a passive device for administering therapy in accordance with certain embodiments;

FIG. 5 shows a handheld device for administering manipulative fascial therapy in accordance with certain embodiments;

FIG. 6 shows various motions that the handheld device can exhibit in accordance with certain embodiments; and

FIG. 7 shows various example removable changeable heads mounted on shaft 80 in accordance with certain embodiments.

### DESCRIPTION OF EXAMPLE EMBODIMENTS

Example embodiments are described herein in the context of system and method for applying therapeutic fascial manipulation. The following description is illustrative only and is not intended to be in any way limiting. Other embodiments will readily suggest themselves to those of ordinary skill in the art having the benefit of this disclosure. Reference will be made in detail to implementations of the example embodiments as illustrated in the accompanying drawings. The same reference indicators will be used to the extent possible throughout the drawings and the following description to refer to the same or like items.

In the description of example embodiments that follows, references to “one embodiment”, “an embodiment”, “an example embodiment”, “certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. The term “exemplary” when used herein means “serving as an example, instance or illustration.” Any embodiment described herein as “exemplary” is not necessarily to be construed as preferred or advantageous over other embodiments.

In the interest of clarity, not all of the routine features of the implementations described herein are shown and described. It will be appreciated that in the development of any such actual implementation, numerous implementation—specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. Devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

Herein, reference to a computer-readable or machine-readable storage medium encompasses one or more non-transitory, tangible storage media possessing structure. As an example and not by way of limitation, a computer-readable storage medium may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101. A computer-readable non-transitory storage medium may be volatile, nonvolatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

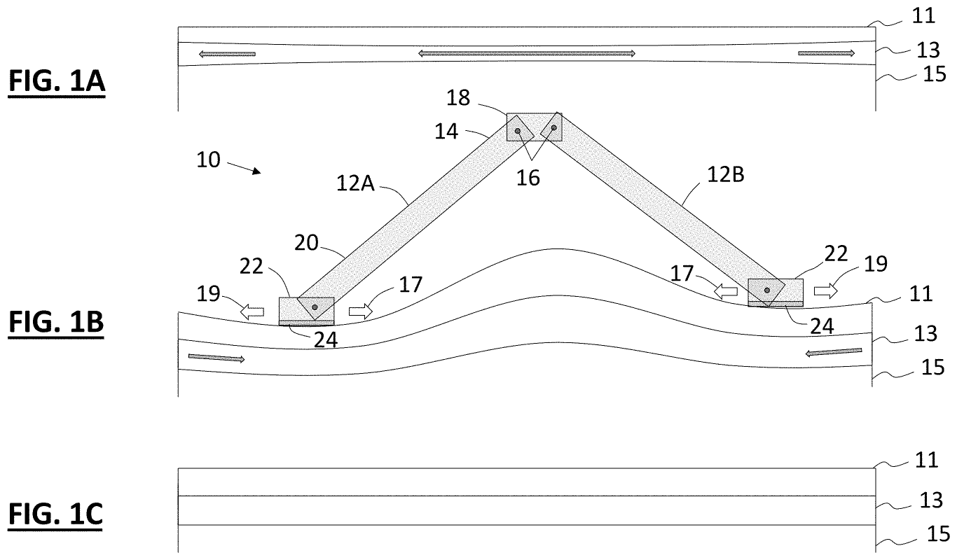

FIGS. 1A-1C are schematic diagrams showing the application of fascial therapy in accordance with certain embodiments. The therapy generally includes application of force through a combination of motions, including a squeezing motion and one or more additional motions, such as a loosening motion, a transverse motion, or a penetrative motion. In certain embodiments, application of force through a squeezing motion only can be applied. For example, the device can be clamped onto a body part and left in place to passively apply pressure to a point or region of interest for a predetermined length of time. In certain embodiments, the force is applied to a patient's body as shown in segment in the drawings, wherein 11 is a surface of the skin or dermis with a layer of adipose tissue, 13 is the superficial fascial layer or fascia, and 15 are underlying layers, such as muscle, deep fascia, and so on. In FIG. 1A, the fascia 13 and possibly muscle and other tissue is shown in a stretched or taught condition, as indicated by the outward pointing arrows, and before application of therapy. This taught condition is debilitating to the patient/user, for example causing pain and tension, poor posture, headaches, chronic shoulder, and neck issues, and so on.

In FIG. 1B, a device 10 for applying therapy to the user's body to address fascial alignment in accordance with certain embodiments is shown. Device 10 is clamp-like and includes opposable digits 12A and 12B having proximal ends 14 where they are movably supported relative to one another, for example about pins 16 disposed in housing 18. In certain embodiments, the housing 18 can be eliminated, and the digits 12A and 12B are directly coupled to one another and pivot about a single pin linking them together (not shown). At distal portions 20 of the digits, platforms 22 having contact pads 24 are disposed. The platforms 22 are optional and the contact pads can alternatively be disposed directly on distal ends 20. The contact pads 24 (or ends of the digits in the alternative embodiment) comprise a grippy, high-friction, grippy, non-slip comfortable and non-injurious material (for example urethane skin, natural rubber, etc.) in order to gain purchase on the skin 11.

Device 10 is operable to apply a squeezing therapy, by imparting a squeezing motion by actuating one or both digits 12A and 12B. The squeezing motion, shown by arrows 17, brings together digit distal portions 20, and their associated contact pads 24, to thereby exert a force that pulls together the skin 11 and underlying tissue, to slacken them and relieve tension therein.

Following the squeezing motion, the contact pads 24 may be retained in place for a period of time as part of the therapy; or they may be moved apart, in a second, loosening motion in the direction of arrows 19. The squeezing and loosening motions may repeated for a period of time, at any desired frequency and extent, with or without pauses, or with random-length pauses, depending on the therapy regimen intended for slackening the fascia and restoring it to a neutral, unstretched and unstressed state, shown in FIG. 1C. In addition to the applied force from the squeezing and/or loosening and other motions of the device itself, a downward force exerted by the operator of the device 10 can be exerted, in the direction of the body, for example to pin the fascia against the bone and thereby loosen it or otherwise treat it therapeutically. The forces applied can reduce the viscosity of hyaluronic acid in the tissue, improving its lubricant properties and facilitating relative movement of tissues. Hyaluronic acid bathes the deep fascia/muscles and may undesirably thicken into viscous form and ultimately cause deep fascia densification. This alteration decreases the threshold of activation for the pain receptors in the deep fascia. Thus, pain signals can easily be perceived due to the irritation of the free nerve endings and receptors within the deep fascia. Fascial manipulation via deep transverse friction massage as described herein can restore the liquidity of the hyaluronic acid, and alleviate chronic musculoskeletal/myofascial pain and other issues.

The therapeutic application can be to any part of the body, such as for instance the forearm, shoulder, neck, back, thigh, calf and so on, and the device 30 can be appropriately sized—for example larger grip opening for larger body parts. Since the fascia is rich with proprioceptors and mechanoreceptors, a decompression/shortening maneuver imparted to the connective tissue and fascia can reduce unnecessary distress signaling from these tissue, reducing local spasms and tightness and relieving short-term and chronic pain and discomfort. The clamp-like structure of device 10 can be adapted and sized for placement on any part of the body, to remain a set period of time until the desired effect, in terms of tissue slackening, viscosity reduction, loosening of any clots or knots, and so on, is achieved. In certain embodiments, the period of time can be about 2 minutes or longer as required to address superficial and deep myofascial densification.

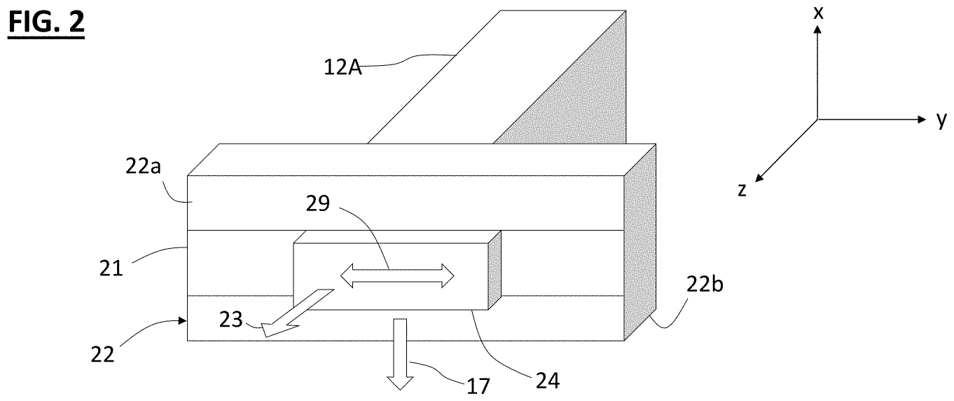

Device 10 may also be configured to apply additional motions as shown in FIG. 2. For example, a track 21 may be provided in platform 22 of any of the digits 12, and pad 24 may be mounted for transverse motion in the track. The transverse motion is indicated by arrow 29. Track 21 may be disposed on surface 22a as shown, or on any other surface of the platform 22, such as surface 22b, to direct its force at a different angle with respect to the patient's skin and body. The transverse motion 29 can be applied at the same time or at different times from one or both the squeezing and loosening motions. A motor and suitable mechanical linkage (not shown) can be used to effect the transverse motion 29 of the pad 24 in track 21. The force provided by reciprocation substantially in the transverse direction 29 can assist with the therapeutic manipulation of the fascia, and with the reduction in viscosity of the hyaluronic acid therein, and can loosen any fascial densification/knots to help restore the hyaluronic acid to its healthy fluid state.

In certain embodiments, it may be desirable to add a force in the direction of the body, referred to as penetrative force, by equipping one or more of the digits 12 with probes that extend outward from the platform 22 (or digit end) and into the body of the patient, in a penetrative motion in the direction of arrow 23 for application of pressure. In certain embodiments a contact pad 24 itself can be made movable in the penetrative direction 23, although probes (not shown) specifically for this purpose can alternatively (or additionally) be used. In a cartesian frame of reference, the three directions can be considered the x, y and z directions, respectively, as shown in the drawing figure, although other directions that are not all along these axes are contemplated. Under this definition, the squeezing 17 and loosening 19 motions are along one axis (x), the transverse motion 29 is along a second, orthogonal axis (y), and the penetrative motion 23 is along a third, orthogonal axis (z). Any or all of these motions can be varied in speed and extent—that is distance traveled by the moving portion (excursions), namely the pad 24. Speed may be variable within each stroke, or it may be variable between strokes. Similarly, pauses of varying or constant duration may be interjected within strokes, or between them. In certain embodiments, speed is controlled to effect a slow, sustained pressure on the body part, and can be as slow as 1 inch per several seconds or tens of seconds.

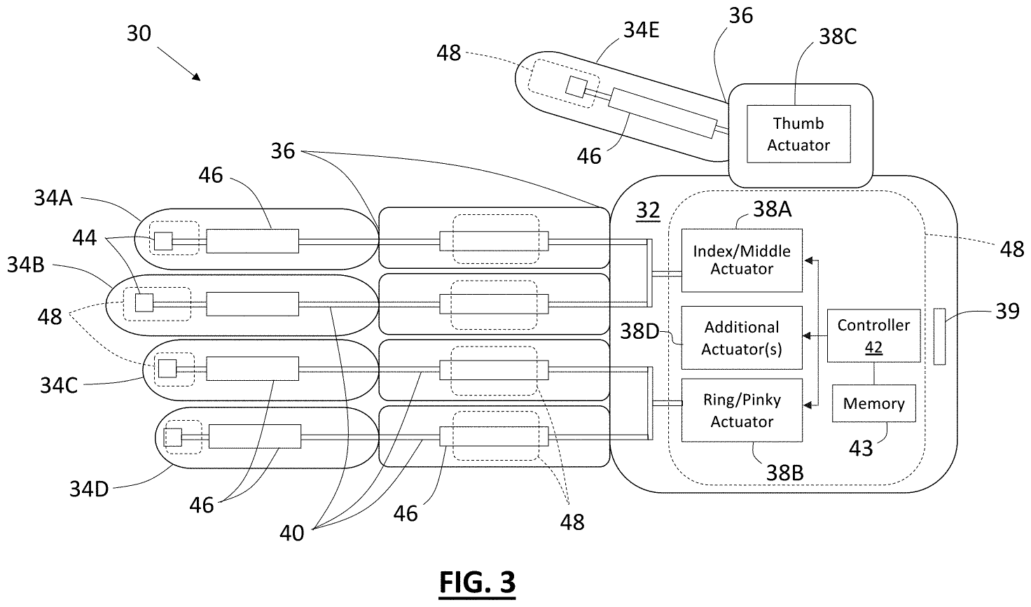

FIG. 3 is a diagram of a multi-articulated device 30, in the form of a robotic hand, for applying therapeutic manipulation as described above and mimicking a human hand in accordance with certain embodiments. The therapy provided by device 30 generally includes application of force through a combination of motions. These can include a squeezing motion and/or one or more other motions, such as a loosening motion, a transverse motion, or a penetrative motion. The squeezing, transverse (planar) and penetrative motions are generally along axes that are transverse to one another, while the squeezing and loosening motions are generally along the same axis but in opposite directions. The device 30, like device 10, is free-standing and does not need to be held by an operator while it applies localized muscle squeezing and kneading, and fascia and other tissue manipulation, providing dual action of massage and posture control/coaching and the other therapy as described above by virtue of its placement on the body of the patient.

Device 30 includes a base or palm 32, which may correspond to housing 18 above, and a plurality of digits or fingers 34A-D, including an opposable thumb digit 34E (collectively, 34). The digits 34 each have one or more segments that are movably connected at joints 36, which lend the device its multi-articulated character and allow it to better conform to the patient's body. Although digits 34A-D as shown each comprise two segments with a joint 36 therebetween, any number of segments greater than (or less than) two is contemplated. Motion of the digits 34 is imparted by actuators 38 in conjunction with steel tendon strings 40 or similar components. Actuator 38A imparts motion to digits 34A, 34B; actuator 38B imparts motion to digits 34C, 34D; and actuator 38C imparting motion to digit 34E (thumb). In certain embodiments, each digit 34 may have its own dedicated actuator, or any other combination of digit/actuator may be used, instead of the pairings herein described. Power to the actuators and other components can be provided by an onboard power supply such as a rechargeable battery (not shown), or through an IO/power interface 39, which also allows programming and communicating with the device using remote devices such as mobile phones, laptop or desktop computers or the like, as further detailed below. In certain embodiments, each of the digits 34 (and palm 32) is provided with a contact pad 48 of grippy, high friction, non-slip material. In certain embodiments, such a contact pad may be part of a skin or laminate that fully or partially encases the digit, including all the segments thereof. The motion provided by the actuators 38 generally corresponds to the squeezing and loosening motions, although mechanical linkages (not shown) can be used between these actuators and the contact pad 48 (and/or suitable probes) to impart the transverse and penetrative motions. Alternatively, the transverse and penetrative motions of the pads 48 or probes can be achieved with dedicated actuators shown generally at 38D.

A processor/controller 42 provides actuation signals selectively to each of the actuators 38 to initiate or terminate its operation in a controllable programmable fashion. For example, a program sequence, stored in memory 43, can be implemented, as a superficial mode, in which slow and steady slackening of the superficial fascia layer through a repetitive gripping and release cycle, of constant or varying magnitude, is applied. As another example, a program sequence as a deep mode for manipulating/releasing of densifications in the deep fascia through a transverse friction mechanism can be applied. As another example, a program sequence for a touch mode, in which little pressure is exerted can be applied, for therapeutically raising Oxytocin feel-good/cuddle hormone level.

Controller 42 is electrically coupled to sensors 44, for example provided at the distal ends or other portions of the digits 34, in order to receive feedback information from the body of the patient during operation. The sensors 44 can be for example surface EMG biometric tension sensors, measuring the amount of resting tension in the muscle so that the device 30 can apply appropriate squeezing, kneading and manipulation. Other types of sensors can be used, such as pressure sensors, temperature sensors, moisture sensors, and the like. Other sensors can include sensors for measuring fascial stiffness and muscle tonicity, for example in the form of a tonometer, a tissue compliance meter or an EMG sensor. In addition, heat transducers 46 can be provided on the digits (or palm, not shown), in order to administer thermal therapy for improved blood flow, comfort and relaxation, based on control by the controller 42 to which the heat transducers are electrically coupled. Therapy in form of electrical pulses, vibrations, light/heat at prescribed wavelengths, etc. can also be administered, by emitters (not shown) similar to heat transducers 46.

As mentioned above, controller 42 is programmable to execute multiple therapy regimens. In certain embodiments, each regimen is associated with one of many users who can use the device 30, and who can gain access to his own regimen through a user interface (not show) that can allow a user to enter identifying information, or through the use of a laptop or desktop computer, smart phone, or the like, that is connectable to the device 30 via I/O interface 39 or wirelessly. In this manner therapy regimens can be customized to users and stored on remote servers, then downloaded into memory 43 as needed. These can be based on payment or prescription from a professional therapist. In certain embodiments the regimens include application of force over multiple squeezing and loosening cycles that repetitively move the high-friction, grippy, non-slip material of the digits toward and away from one another in the squeezing and loosening motions described above, and/or move the high-friction, grippy, non-slip material in the transverse and penetrative directions, or any combination of motions and pauses. The frequency and regularity of the repetition of these motions, as well as the extent and magnitude of the force applied, can be specific to the therapeutic regimen desired and can be preprogrammed or user controlled in real-time during operation, for example using a remote control (not shown) in communication with controller 42. In certain embodiments, a mobile application or other remote program running on a different device, such as a smart phone, desktop or laptop computer, or the like, can be configured to control the device 30 or augment its functionality and features, for example providing bio measurement feedback about the fascia (stiffness/tone), disseminating knowledge about fascia health and pertinent exercises (akin to a virtual physiotherapist), and providing an interface for programming and accessing the device. In certain embodiments, the application can provide an educational platform for resources on fascial health with respect to nutrition, proper posture, body mechanics, and flexibility exercises and other pertinent information. Thus in certain embodiments the controller 42 is in communication with the mobile application or other remote program and can exchange commands or information that relate to one or more of device operation, patient data, educational information, and the like.

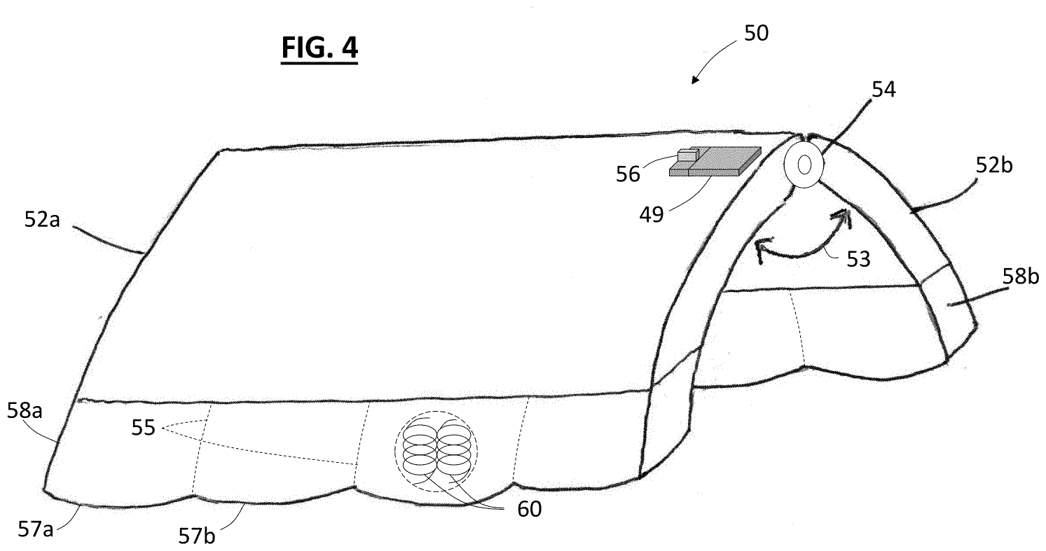

In certain embodiments, the device for administering therapy can be passive, taking a clamp-like form in which the user clamps it onto the desired body site, and leaves it there for a desired period of time. It has been found that applying such clamping force, even without additional motions, can achieve therapeutic benefits, for example by creating pressure and/or compression around a swollen joint and forcing the swelling to move out of the region through the lymphatic system. The applied therapy can create a shearing effect to restore the slidability of the myofascial connective tissue. The pressure/tack like maneuver compresses the myofascial tissues against the bone; the patient moves the body part against this compression, essentially “flossing” the connective tissue against the bone, which helps with active therapeutic release of the connective tissue, alleviating stiffness. A passive device 50 of this type is shown in FIG. 4. It includes two hinged clam-shell portions 52a and 52b. They are manually movable toward and away from each other in a clamping motion indicated by arrow 53. Hinge 54 permits this motion. A brake mechanism 49 may also be included, for selectively substantially locking the clam-shell portions 52a and 52b in a desired relative position. In certain embodiments, brake 49 may apply user-adjustable resistive pressure without fully locking the clam-shell portions 52a and 52b in place. In certain embodiments, brake 49 may for example be ratcheting teeth or another expedient (not shown) to substantially maintain the relative position of the clam shell portions 52a and 52b once the desired amount of closure (and exerted pressure on the selected body portion) is achieved. The brake, ratcheting or resistance can be released or slackened by a switch or button 56, and the device re-opened to release pressure or to be redeployed on a different body part. Opening and/or closure can be performed manually by the user, or using a powered actuator (not shown).

One feature of device 50 is that clam-shell portions 52a and 52b, or at least parts thereof, may be configured to be malleable so that they include a conformable interface that conforms to the particular body part being clasped. Suitable material to achieve this conformability include for example urethane, rubber, silicone or material. In certain embodiments, only a portion, such as end portions 58a and 58b, is conformable, while the rest is substantially firm and unmalleable. In certain embodiments, conformability can be achieved by using concealed springs 60 in end portions 58a and 58b that exert a bias towards the ends of the clam-shell portions 52a and 52b. Other ways of providing a conformable interface are contemplated, such as fluid-filled or selectively inflatable bladders and the like. In certain embodiments, clam-shell portions 52a and 52b, or portions thereof such as end portions 58a and 58b, can be slotted, along lines 55, such that resulting fingers, for example fingers 57a and 57b, move independently of each other and of other fingers. It is also contemplated that in certain embodiments, the conformable portions are not integral with the clam shell portions, but are separate components attached thereto, and provide a conformable interface for secure contact with the body part of interest. In other embodiments the conformable portions are integral with the clam shell portions and provide the conformable interface for secure contact with the body part of interest.

In addition, device 50 may include sensors (not shown) such as pressure sensors, temperature sensors, moisture sensors, sensors for measuring fascial stiffness and muscle tonicity such as tonometers, tissue compliance meters or an EMG sensors. Heat transducers (not shown) can also be provided, and/or devices to administer electrical pulses, vibrations, light/heat at prescribed wavelengths.

In certain embodiments, passive device 50 may have features that incorporate some of the motions described above. For example, fingers 57a and 57b can be made movable in a penetrative direction, towards the patient's tissue, or pads provided with side-to-side (transverse motion) can be affixed to the ends of the fingers or at other portions of the clam-shell portions 52a and 52b such as their end portions 58a and 58b.

Thus in certain embodiments device 50 can be equipped with a controller similar to controller 42 and can be remotely accessible. The device can thus be in communication with a mobile application or other remote program, for example to exchange commands or information that relate to one or more of device operation, patient data, educational information and the like.

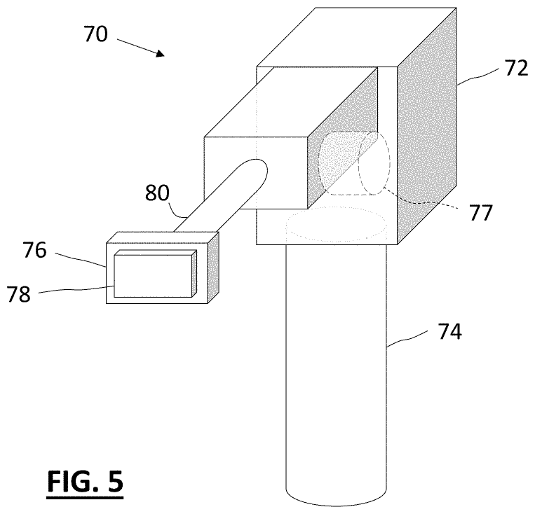

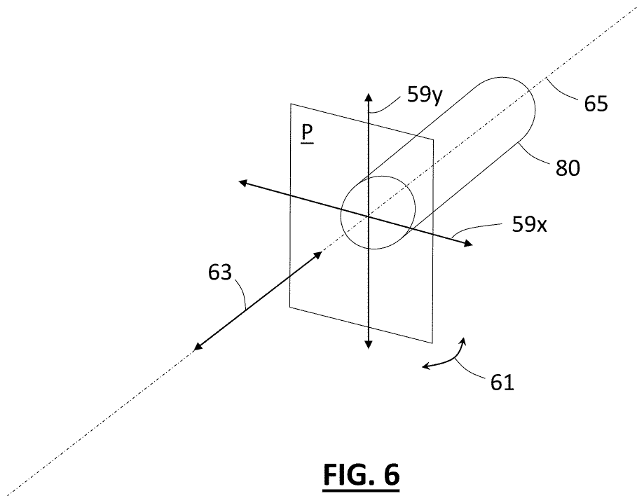

FIG. 5 shows a handheld device 70 for administering therapy. The hand-held form factor of device 70 enables a user to apply more power than the free-standing devices 30 and 50 described above, for example through greater leverage, or manipulation of bodyweight. Device 70 includes a housing 72 and a grip or handle portion 74 with which the user, who can be the patient himself, holds the device and administers the therapy. Handle 74 can be integrated in the housing and need not necessarily protrude prominently therefrom, as long as it is configured to provide the user with a firm grip with which to apply pressure and leverage as necessary. Device 70 also includes a movable head 76 on which is mounted a contact pad 78 to be pressed against the patient's body during operation. Like contact pads 24 and 48, contact pad 78 comprises a grippy, high-friction, non-slip, comfortable and non-injurious material (for example urethane skin, natural rubber, silicone, ribbed silicone, Gecko etc.) of any desired shape and size that allows purchase on the patient's skin in order to induce movement of the myofascial and other tissue in the desired manner. Housing 72 supports a motor 77 that provides motion to movable head 76, for example by way of a shaft 80 or other mechanical linkage. As seen in FIG. 6, the motion can be any combination of or additional motions (elliptical for instance), that are generally repetitive, with or without pauses (although random motion is also contemplated), and lie in a plane P parallel to the patient's skin. The motions are adjustable, by the user or by a program sequence of a controller such controller 42, in both extent, speed, frequency of repetition, and duration of pauses. In certain embodiments the speed of the excursions can be as slow as one inch every few seconds or tens of seconds. In certain embodiments, motion axially along shaft 80, in the direction of the patient's body, can be added to the other motions, and can also be adjustable in extent and frequency and pauses. In FIG. 6, translational motion 59x and 59y and rotational motion 61 are all in the same plane, substantially parallel to the skin of the patient, and axial motion 63 is normal to that plane. Rotational motion 61 can be a repetitive twisting back and forth, through a limited arc, for example 5 to 90 degrees, about the axis 65, whereas in revolutionary motion, contact pad 78 and shaft 80 circle in their entirety in orbits around central axis 65. All of these motions can include different-duration pauses among them, and any combination of these motions and pauses can be used.

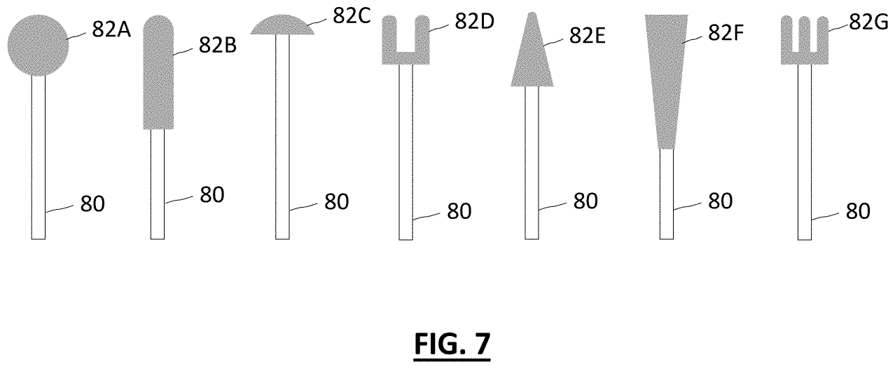

While shown as generally rectangular in shape, contact pad 78 may have other shapes, and moving head 76 supporting it may be similarly shaped. In certain embodiments, the contact pad 78 is integral with moving head 76, and these components can comprise a changeable head that can be removably attached to shaft 80, depending on the type of therapy to be administered, the size of the body part, and so on. Various example removable changeable heads 82A-82G, mounted on shaft 80, are shown in FIG. 7 (not to scale). In certain embodiments, removable changeable heads 82A-82G are made of a pliable material, such as rubber, silicone, urethane, and the like. In certain embodiments, the moving head 76, contact pad 78, and shaft 80 are integrally formed, and are removable from device 70 and interchangeable, to provide different head configurations, as one component.

In certain embodiments, device 70 can include sensors such as pressure sensors, temperature sensors, moisture sensors, sensors for measuring fascial stiffness and muscle tonicity such as tonometers, tissue compliance meters or an EMG sensors. Heat transducers can also be provided, and/or devices to administer electrical pulses, vibrations, light/heat at prescribed wavelengths. Any of movable heads 82A-82G can support such devices, using suitable electrical connections to a processor (not shown) such as processor 42 in housing 72 that pass through shaft 80.

In addition, similarly to device 30, a controller (not shown) of device 70 can be programmable to execute multiple therapy regimens associated with one of multiple authorized users. Therapy regimens can be customized to users and stored on remote servers, then downloaded as needed, and can be based on payment or prescription from a professional therapist. A mobile application or other remote program running on a different device, such as a smart phone, desktop or laptop computer, or the like, can be configured to control the device 70 or augment its functionality and features, for example providing bio measurement feedback about the fascia (stiffness/tone), disseminating knowledge about fascia health and pertinent exercises (akin to a virtual physiotherapist), and providing an interface for programming and accessing the device and some or all of its features. Thus in certain embodiments the controller is in communication with the mobile application or other remote program and can exchange commands or information that relate to one or more of device operation, patient data, educational information and the like.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted based on the foregoing description. This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A free-standing device for applying manipulative myofascial therapy comprising:
one or more actuators;
at least two opposable digits that are movably supported relative to one another at proximal ends thereof, each opposable digit having a contact pad of high-friction material at a portion thereof; and
a controller operable to signal one or more of the actuators to:
impart to at least a first opposable digit of the one or more opposable digits a squeezing motion to thereby move the contact pad thereof toward a contact pad of a second opposable digit of the one or more opposable digits, and
impart to a contact pad of an opposable digit of the one or more opposable digits at least one of a loosening motion, a transverse motion, or a penetrative motion.

2. The device of claim 1, wherein the squeezing, transverse and penetrative motions are generally along axes that are transverse to one another, and the squeezing and loosening motions are generally along the same axis but in opposite directions.

3. The device of claim 2, further comprising one or more sensors for providing feedback signals to the controller, the one or more sensors selected from pressure sensors, temperature sensors, moisture sensors, sensors for measuring fascial stiffness and sensors for measuring muscle tonicity.

4. The device of claim 1, wherein one or more of the motions is adjustable in one or more of extent, speed, or pauses therein.

5. The device of claim 1, further comprising one or more devices for administering one or more of heat, electrical pulses, vibrations, or light.

6. The device of claim 1, further comprising a probe for applying pressure.

7. The device of claim 1, wherein the number of digits is five and the device is in the form of a human hand.

8. The device of claim 1, wherein the controller is configured to signal the actuators in accordance with a pre-programmed sequence.

9. The device of claim 1, wherein the contact pad is formed of a urethane skin or natural rubber.

10. The device of claim 1, wherein the contact pad is part of a skin or laminate that fully or partially encases the opposable digit.

11. The device of claim 1, wherein the motions are adjustable, by the user or by a program sequence, in both extent and frequency of repetition, and in duration of pauses.

12. The device of claim 1, wherein the controller is configured to communicate with a remote device for exchange of commands or information therewith, the commands or information relating to one or more of device operation, patient data, and educational information.

13. A handheld device for applying manipulative myofascial therapy comprising:
a housing;
a handle coupled to the housing;
a motor supported in the housing;
a movable head coupled to the motor; and
a contact pad of high-friction material supported on the movable head,
wherein the motor is operable to impart to the movable head and the contact pad one or more of translational, rotational, or revolutionary motions that are generally in a plane parallel to the skin of a patient during operation.

14. The device of claim 13, wherein the contact pad is formed of a urethane skin, silicone, natural rubber, or other non-slip grippy material.

15. The device of claim 13, wherein the motions are adjustable, by the user or by a program sequence, in both extent and frequency of repetition, and in duration of pauses.

16. The device of claim 13, wherein the movable head is removable and interchangeable with other movable heads.

17. The device of claim 13, further comprising one or more sensors selected from pressure sensors, temperature sensors, moisture sensors, sensors for measuring fascial stiffness and sensors for measuring muscle tonicity.

18. The device of claim 13, further comprising one or more devices for administering one or more of heat, electrical pulses, vibrations, or light.

19. The device of claim 13, further comprising a controller configured to communicate with a remote device for exchange of commands or information therewith, the commands or information relating to one or more of device operation, patient data, and educational information.

20. A free-standing device for applying manipulative myofascial therapy comprising:
first and second clam shell portions hingeably supported for movement relative to one another in opening and closing motions; and
a brake for selectively substantially retaining the relative position of the first and second claim shell portions,
wherein each of the first and second clam shell portions includes a conformable portion for conforming to a shape of a body part when the two clam-shell portions are closed against said body part.

21. The device of claim 20, wherein the conformable portion comprises springs.

22. The device of claim 20, wherein the conformable portion comprises independently movable fingers.

23. The device of claim 20, further comprising one or more sensors selected from pressure sensors, temperature sensors, moisture sensors, sensors for measuring fascial stiffness and sensors for measuring muscle tonicity.

24. The device of claim 20, further comprising one or more devices for administering one or more of heat, electrical pulses, vibrations, or light.

25. The device of claim 20, further comprising a controller is configured to communicate with a remote device for exchange of commands or information therewith, the commands or information relating to one or more of device operation, patient data, and educational information.
